(19) United States
(12) Patent Application Publication
(10) Pub. No.: US 2024/0255678 A1
(43) Pub. Date: Aug. 1, 2024

(54) Optically Diffusive Film and Method of Making Same

(71) Applicant: 3M INNOVATIVE PROPERTIES COMPANY, St. Paul, MN (US)

(72) Inventors: Carl A. Stover, St. Paul, MN (US); Benjamin J. Forsythe, Stillwater, MN (US); David A. Rosen, North St. Paul, MN (US); Stephen A. Johnson, Woodbury, MN (US)

(21) Appl. No.: 18/560,744

(22) PCT Filed: May 5, 2022
(86) PCT No.: PCT/IB2022/054163

§ 371 Date: Nov. 14, 2023

Related U.S. Application Data
(60) Provisional application No. 63/193,842, filed on May 27, 2021.

(51) Int. Cl. G02B 5/02; B29D 11/00; G02B 1/04; G02B 5/30

(52) U.S. Cl. CPC G02B 5/0242; B29D 11/00798; G02B 1/04; G02B 5/0268; G02B 5/3083

(57) ABSTRACT

An optically diffusive film (200) includes a plurality of particles (10) dispersed in a binder (20). The particles (10) and the binder (20) have respective indices n1b and n2b along a same in-plane block-direction of the optically diffusive film (200), and respective indices n1p and n2p along an in-plane pass-direction orthogonal to the block-direction, such that for at least a first wavelength in a first wavelength range extending from about 400 nm to about 1000 nm: a magnitude of a difference between n1b and n2b is greater than about 0.05; and a magnitude of a difference between n1p and n2p is less than about 0.05. For substantially normally incident light and for at least the first wavelength, the optically diffusive film (200) may be more optically diffuse for a light polarized along a block-direction (b) and less optically diffusive for light polarized along an orthogonal pass-direction (p).

### SUMMARY

The present description generally relates to optically diffusive films that include particles dispersed in a binder and to methods of making optically diffusive films that include extruding an immiscible blend. The optically diffusive film may be more optically diffusive for a light polarized along a block-direction and less optically diffusive for light polarized along an orthogonal pass-direction.

In some aspects, the present description provides an optically diffusive film including a plurality of particles dispersed in a binder. The particles and the binder have respective indices n1b and n2b along a same in-plane block-direction of the optically diffusive film, and respective indices nip and n2p along an in-plane pass-direction orthogonal to the block-direction, such that for at least a first wavelength in a first wavelength range extending from about 400 nm to about 1000 nm: a magnitude of a difference between n1b and n2b is greater than about 0.05; and a magnitude of a difference between nip and n2p is less than about 0.05. In some embodiments, for a substantially normally incident light having the first wavelength, the optically diffusive film has: a diffuse optical transmittance TDb and a diffuse optical reflectance RDb when the incident light is polarized along the block-direction, where TDb/RDb≥4; and a total optical transmittance TTp and a diffuse optical transmittance TDp when the incident light is polarized along the pass-direction, where TTp/TDp≥1.1. In some such embodiments, or in other embodiments, for a substantially normally incident light having the first wavelength, the optically diffusive film has: a total optical transmittance TTb and a total optical reflectance RTb when the incident light is polarized along the block-direction, where TTb/RTb≥2; and a total optical transmittance TTp and a total optical reflectance RTp when the incident light is polarized along the pass-direction, where TTp/RTp≥6. In some such embodiments, or in other embodiments, for a substantially normally incident light having the first wavelength, the optically diffusive film has specular optical transmittances TSp and TSb when the incident light is polarized along the respective pass- and block-directions, where TSp/TSb≥2.

In some aspects, the present description provides an extruded optically diffusive film extruded along a pass-direction and including: a plurality of particles dispersed in a binder, where the particles are elongated along substantially a same in-plane block-direction orthogonal to the pass-direction and have an average aspect ratio of greater than about 5; and a plurality of substantially parallel extrusion die-lines making an angle of less than about 20 degrees with the pass-direction. In some embodiments, for a substantially normally incident light having a first wavelength in a first wavelength range extending from about 400 nm to about 1000 nm, the optically diffusive film has: a diffuse optical transmittance TDb and a diffuse optical reflectance RDb when the incident light is polarized along the block-direction, where TDb/RDb≥4; and a total optical transmittance TTp and a diffuse optical reflectance RDp when the incident light is polarized along the pass-direction, where TTp/RDp≥10. In some such embodiments, or in other embodiments, for a substantially normally incident light having the first wavelength, the optically diffusive film has specular optical transmittances TSp and TSb when the incident light is polarized along the respective pass- and block-directions, where TSp/TSb≥2.

In some aspects, the present description provides a method of making an optically diffusive film. The method includes extruding an immiscible blend of a minor phase material and a major phase material through a die and along a pass-direction at a first temperature greater than glass transition temperatures of the minor and major phase materials resulting in an extruded mixture at substantially the first temperature and comprising a plurality of substantially spherical domains; and stretching the extruded mixture along a block-direction, substantially orthogonal to the pass-direction, at a second temperature less than the first temperature resulting in a plurality of particles dispersed in a binder. The binder and each of at least a majority of the particles have respective indices n2b and n1b along the block-direction and respective indices n2p and nip along the pass-direction, such that for at least a first wavelength in a first wavelength range extending from about 400 nm to about 1000 nm: a magnitude of a difference between n1b and n2b is greater than about 0.05; and a magnitude of a difference between nip and n2p is less than about 0.05.

These and other aspects will be apparent from the following detailed description. In no event, however, should this brief summary be construed to limit the claimable subject matter.

### BRIEF DESCRIPTION OF THE DRAWINGS

FIGS. 1A-1B are schematic top and cross-sectional views, respectively, of an optically diffusive film, according to some embodiments.

FIGS. 2A-2B are schematic top and cross-sectional views, respectively, of another optically diffusive film, according to some embodiments.

FIG. 3 is a plot of a ratio of a diffuse optical transmittance to a diffuse optical reflectance for a block state and a ratio of a total optical transmittance to a diffuse optical transmittance for a pass state versus wavelength, according to some embodiments.

FIG. 4 is a plot of a ratio of a total optical transmittance to a diffuse optical reflectance for a pass state and a ratio of a total optical transmittance to a total optical reflectance for a pass state versus wavelength, according to some embodiments.

FIG. 5 is a plot of intensity distribution of the optical transmittance of an optically diffusive film for block state light and for scattering angles in orthogonal planes, according to some embodiments.

FIG. 6 is a plot of a ratio of a total optical transmittance to a total optical reflectance for a block state and a ratio of a total optical transmittance to a total optical reflectance for a pass state versus wavelength, according to some embodiments.

FIG. 7 is a plot of a ratio of a specular optical transmittance for a pass state to a specular optical transmittance for a block state and a ratio of total optical transmittance for a pass state to a total optical transmittance for a block state versus wavelength, according to some embodiments.

FIG. 8 is a schematic process flow diagram of a method of making an optically diffusive film, according to some embodiments.

FIGS. 9A-9B are micrographs of cross-sections of an exemplary extruded mixture.

FIGS. 10A-10B are micrographs of cross-sections of another exemplary extruded mixture.

FIG. 11 is a plot of intensity distributions of optical transmittances of exemplary optically diffusive films for light polarized along a block direction and for scattering angles in a plane orthogonal to the block direction.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

According to some embodiments of the present description, an optically diffusive film has a higher haze for light polarized along a first direction (which may also be referred to as a “block” direction) than for light polarized along an orthogonal second direction (which may also be referred to as a “pass” direction) and may have a larger scattering in a plane define by the second direction and a thickness direction than in a plane defined by the first and thickness directions. The optically diffusive film may be useful, for example, in display or sensor applications. For example, a display can be constructed where light passes through a liquid crystal display (LCD) panel with a narrow viewing angle (e.g., after passing through crossed prism films) and on the exit side of the LCD panel, the optically diffusive film can be disposed with the second direction oriented horizontally to broaden the viewing angle in the horizontal plane. As another example, the optically diffusive film can be used with a % wave retarder on an optical device (e.g., an optical sensor) so that when light polarized along the block direction is incident on the device with a broad angular distribution and any such light that is reflected from the device back toward the optically diffusive film through the retarder is incident on the optically diffusive film in the lower scattering pass state and/or so that when light polarized along the pass direction is incident on the device with a narrow angular distribution and any such light reflected from the device back toward the optically diffusive film through the retarder is incident on the optically diffusive film in the block state and is substantially transmitted through the optically diffusive film with a wider angular distribution.

According to some embodiments of the present description, an optically diffusive film includes a plurality of particles dispersed in a binder where the particles are substantially optically isotropic (e.g., a difference between largest and smallest refractive indices of the particles for at least one wavelength in a range of about 400 nm to about 1000 nm can be less than about 0.05, or less than about 0.04, or less than about 0.03, or less than about 0.02, or less than about 0.01) and where the binder is birefringent (e.g., a difference between largest and smallest refractive indices of the binder for at least one wavelength in a range of about 400 nm to about 1000 nm can be greater than about 0.05, or greater than about 0.06, or greater than about 0.07, or greater than about 0.08, or greater than about 0.09, or greater than about 0.1 and the difference may be up to about 0.35, or up to about 0.3, or up to about 0.25, for example). A difference in refractive indices of the binder and the particles can be substantially different (e.g., differ by greater than about 0.05, or greater than about 0.06, or greater than about 0.07, or greater than about 0.08, or greater than about 0.09, or greater than about 0.1 and the difference may be up to about 0.35, or up to about 0.3, or up to about 0.25, for example) along a first direction and substantially matched (e.g., differ by less than about 0.05, or less than about 0.04, or less than about 0.03, or less than about 0.02, or less than about 0.01) along an orthogonal second direction. The particles may be elongated along the first direction which can result larger scattering in the second direction (i.e., in a scattering plane comprising the second direction) than in the first direction.

The optical properties of the optically diffusive film can be adjusted by selecting the binder and particle materials to have differences in refractive indices in desired ranges along the block and pass axes, adjusting the number or volume of the particles, and adjusting the shape of the particles. Increasing the refractive index difference in the block direction generally increases scattering in the block polarization state. Increasing the number of particles also increases the scattering. The index difference and the number of particles can be selected to result in mostly forward scattering, for example. The optically diffusive film can be formed by extrusion followed by stretching (e.g., using a standard (linear) tenter or a nonlinear tenter such as a parabolic tenter) as described further elsewhere herein. The draw ratio used in the stretching can affect the refractive index of the binder (e.g., increasing in the draw direction for positively birefringent polymers) and the shape of the particles (e.g., resulting in particles elongated along the draw direction). The draw ratio can be at least about 1:1, or at least about 2:1, or at least about 3:1, or at least about 4:1, or at least about 4.5:1 and may be up to about 30:1, or up to about 20:1, or up to about 15:1, or up to about 10:1, or up to about 8:1, or up to about 7:1, for example. The draw ratio may be in a range from about 3:1 to about 10:1, or from about 4:1 to about 8:1, or from about 4.5:1 to about 7:1, for example. It has been found that elongating the particles along the draw direction, which may also be the block direction, can result in increased scattering in a scattering plane orthogonal to draw direction.

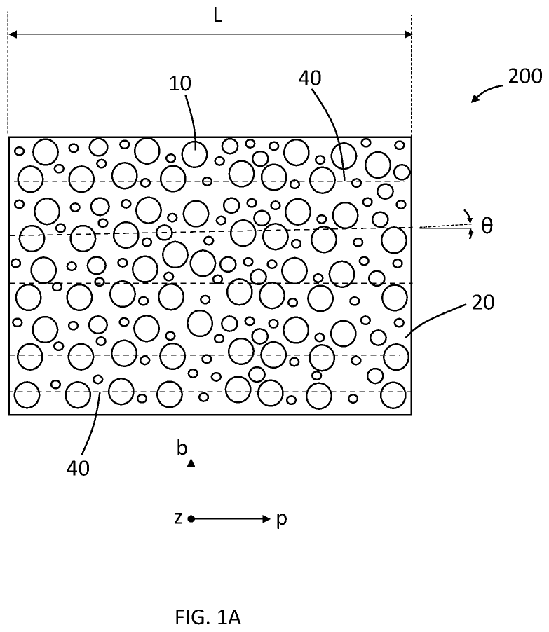

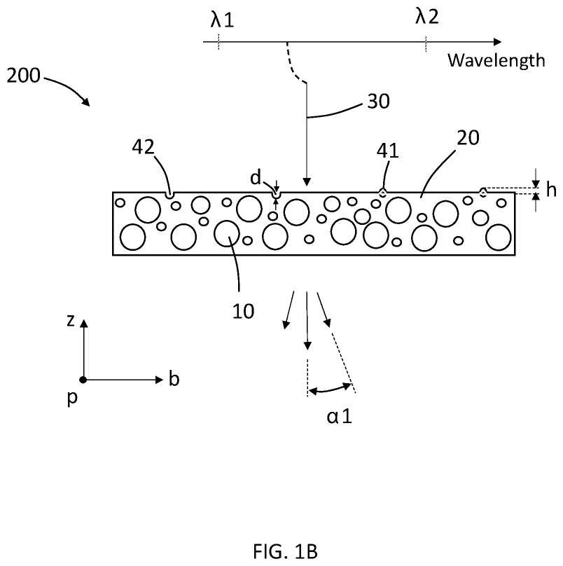

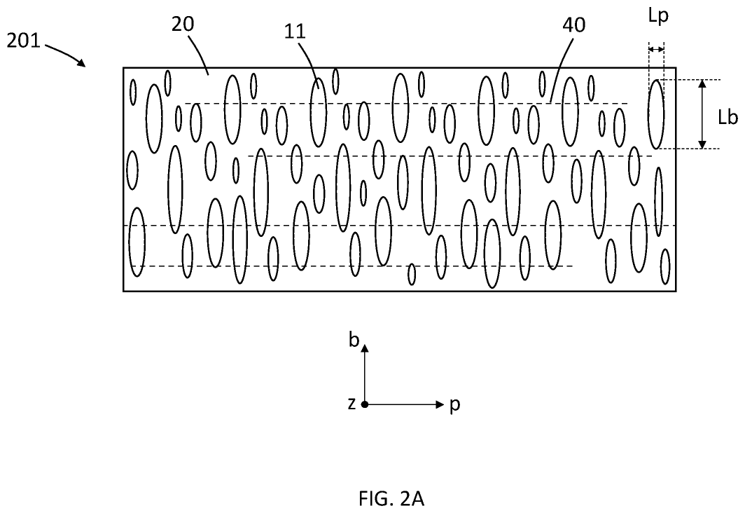

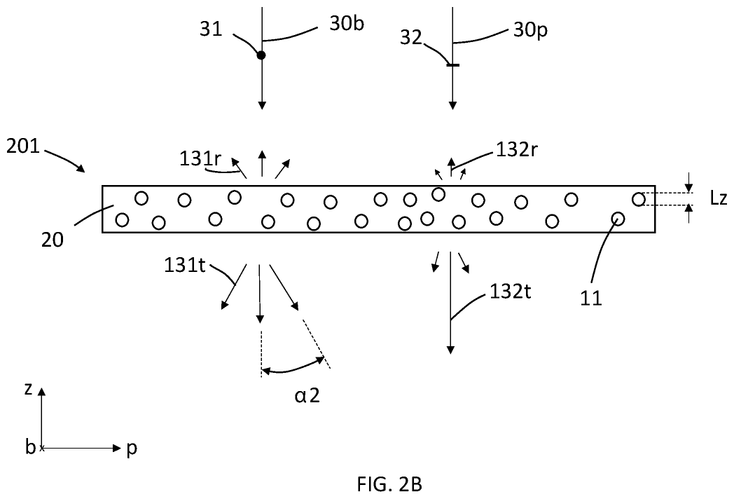

FIGS. 1A-1B are schematic top and cross-sectional views, respectively, of an optically diffusive film 200 including particles 10 dispersed in a binder 20, according to some embodiments. FIGS. 2A-2B are schematic top and cross-sectional views, respectively, of an optically diffusive film 201 including particles 11 dispersed in a binder 20, according to some embodiments. The film 200, 201 extends along orthogonal in-plane first (block direction or b-direction) and second (pass direction or p-direction) and has a thickness along a z-direction orthogonal to the b-and p-directions. In FIG. 2B, the particles 11 are elongated along the b-direction. The particles 11 can have an Lb/Lp ratio substantially higher than schematically illustrated in FIG. 2A. FIG. 2B schematically illustrates substantially normally incident light 30b polarized along the block-direction (polarization state 31) and substantially normally incident light 30p polarized along the pass-direction (polarization state 32). A portion 131t of the light 30b is transmitted and a portion 131r of the light 30b is reflected. A portion 132t of the light 30p is transmitted and a portion 132r of the light 30p is reflected. Each portion 131t, 131r, 132t, 132r is schematically illustrated as including specular and diffuse portions. A total optical reflectance can be determined by measuring the reflectance using an integrating sphere to collect all reflected light of a given wavelength or wavelength range. A diffuse optical reflectance, which may also be referred to as a specular excluded reflectance, can be determined by measuring the reflectance using an integrating sphere where light corresponding to a specular reflection is allowed to escape from the integrating sphere. Alternatively, in some embodiments, the total and diffuse optical reflectances may approximated as 100% minus total and diffuse transmittances, respectively, which may be determined according to the ASTM D1003-13 test standard. A specular optical reflectance can be determined as a difference between total and diffuse optical reflectances. The film 200, 201 has a length L which may be greater than about 40 inches, or greater than about 45 inches, or greater than about 50 inches, or greater than about 55 inches, or greater than about 60 inches along the pass-direction. For example, the film 200, 201 can be formed by extrusion along the p-direction and may be formed in a continuous roll-to-roll process where the length L can be tens or hundreds of yards, for example. The film 200, 201 may have an average thickness in a range of about 30 to about 250 micrometers, or about 40 to about 200 micrometers, or about 50 to about 150 micrometers, for example.

The binder 20 and the particles 10, 11 have refractive indices along each of the illustrated b-, p-, and z-directions. In some embodiments, an optically diffusive film 200, 201 includes a plurality of particles 10, 11 dispersed in a binder 20, where the particles and the binder have respective indices n1b and n2b along a same in-plane (pb-plane) block-direction (b-direction) of the optically diffusive film 200, 201, and respective indices nip and n2p along an in-plane pass-direction (p-direction) orthogonal to the block direction, such that for at least a first wavelength in a first wavelength range extending from about 400 nm to about 1000 nm: a magnitude of a difference between n1b and n2b is greater than about 0.05; and a magnitude of a difference between nip and n2p is less than about 0.05. In some such embodiments, or in other embodiments, for at least the first wavelength, a magnitude of a difference between n1b and n2b is greater than about 0.05, or greater than about 0.06, or greater than about 0.07, or greater than about 0.08, or greater than about 0.09, or greater than about 0.1. In some such embodiments, or in other embodiments, for at least the first wavelength, magnitude of a difference between nip and n2p is less than about 0.05, or less than about 0.04, or less than about 0.03, or less than about 0.02, or less than about 0.01.

The at least a first wavelength may include one or more wavelengths in a second wavelength range narrower than the first wavelength range. For example, the at least a first wavelength may include one or more wavelengths in a second wavelength range of about 400 nm to about 700 nm, or about 420 nm to about 680 nm, or about 450 nm to about 650 nm, for example. Alternatively, the first wavelength range may be a narrower range than about 400 nm to about 1000 nm (e.g., the first wavelength range may be any of the ranges described for the second wavelength range). A wavelength range (e.g., corresponding to the first or second wavelength ranges) extending from λ1 to λ2 is schematically illustrated in FIG. 1B. λ1 may be about 400 nm, or about 420 nm, or about 450 nm, for example. λ2 may be about 1000 nm, or about 850 nm, or about 700 nm, or about 680 nm, or about 650 nm, for example. The at least the first wavelength may include one or more of about 532 nm, about 550 nm, about 631 nm, about 633 nm, or about 900 nm, for example.

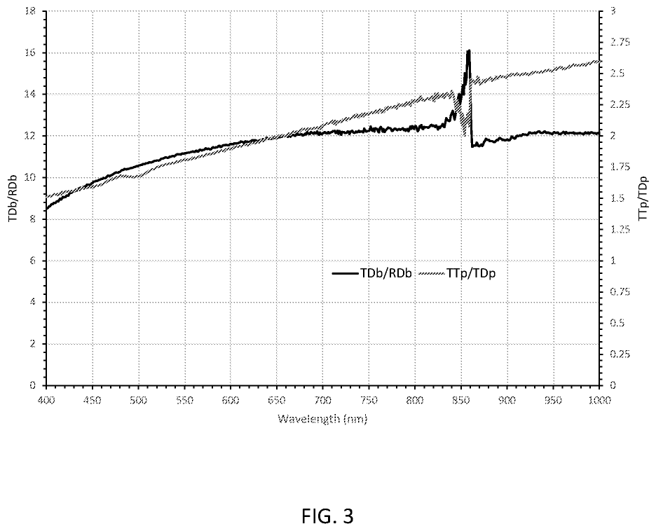

In some embodiments, for a substantially normally incident light 30 having the first wavelength, the optically diffusive film 200, 201 has: a diffuse optical transmittance TDb and a diffuse optical reflectance RDb when the incident light is polarized along the block-direction, TDb/RDb≥4; and a total optical transmittance TTp and a diffuse optical transmittance TDp when the incident light is polarized along the pass-direction, TTp/TDp≥1.1. A low backscattering (e.g., as quantified by a TDb/RDb of at least 4) for light polarized along the block-direction may be desired while a limited diffuse transmittance relative to total transmittance (e.g., as quantified by a TTp/TDp of at least 1.1) for light polarized along the pass-direction may be desired in some applications. FIG. 3 is a plot of TDb/RDb and TTp/TDp versus wavelength, according to some embodiments. Typically, TDb/RDb generally increases when reducing the number of particles included in the binder and/or when reducing the refractive index difference between the particles and the binder along the block-direction so that there is less backscattering. Typically, TTp/TDp generally increases when reducing the number or volume of particles included in the binder and/or when reducing the refractive index difference between the particles and the binder along the pass-direction. In some embodiments, TDb/RDb≥4, or TDb/RDb≥5, or TDb/RDb≥6, or TDb/RDb≥7, or TDb/RDb≥7, or TDb/RDb≥9, or TDb/RDb≥10, or TDb/RDb≥11. In some such embodiments, or in other embodiments, TTp/TDp≥1.1, or TTp/TDp≥1.25, or TTp/TDp≥1.5, or TTp/TDp≥1.75, or TTp/TDp≥2, or TTp/TDp≥2.25, or TTp/TDp≥2.5. TDb/RDb may be up to about 25, or up to about 20, or up to about 18, for example. TTp/TDp may be up to about 5, or up to about 4, or up to about 3, for example. The peak in FIG. 3, and in other plots of a ratio versus wavelength, that occurs around 850 nm is believed to be due to a detector switch in the spectrophotometer used in the measurements.

Substantially normally incident light may be within 30 degrees, or 20 degrees, or 10 degrees of normal, or may be nominally normal, for example. For obliquely incident light, the light may be described as polarized along the block- or pass-directions when the polarization state projected onto the bp-plane is along the respective block- or pass-directions.

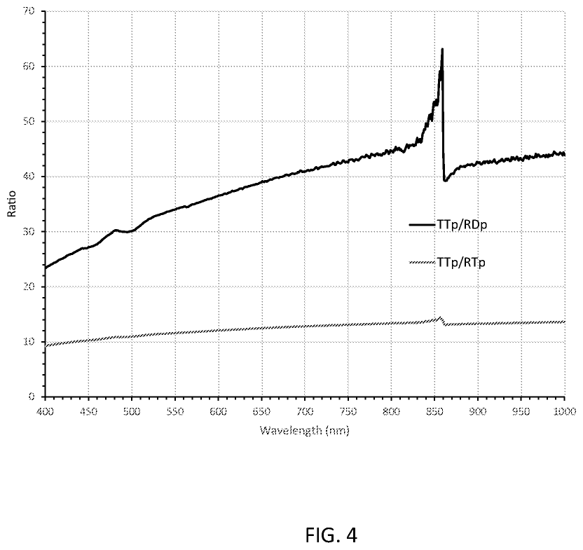

In some embodiments, for the substantially normally incident light 30 having the first wavelength, the optically diffusive film 200, 201 has a diffuse optical reflectance RDp when the incident light is polarized along the pass-direction. A low backscattering (e.g., as quantified by a TTp/RDp being at least 10 and/or as quantified by TTp/RTp, described elsewhere, being at least 6) for light polarized along the pass-direction may be desired in some applications. In some embodiments, TTp/RDp≥10, or TTp/RDp≥15, or TTp/RDp≥20, or TTp/RDp≥25, or TTp/RDp≥30, or TTp/RDp≥35. In some such embodiments, or in other embodiments, for the substantially normally incident light 30 having the first wavelength, the optically diffusive film 200, 201 has a total optical reflectance RTp when the incident light is polarized along the pass-direction, where TTp/RTp≥6, or TTp/RTp≥7, or TTp/RTp≥8, or TTp/RTp≥9. Typically, TTp/RDp and TTp/RTp generally increase when reducing the number or volume of particles included in the binder and/or when reducing the refractive index difference between the particles and the binder along the pass-direction. TTp/RDp can be up to about 100, or up to about 80, or up to about 70, for example. TTp/RTp can be up to about 25, or up to about 20, or up to about 18, for example. FIG. 4 is a plot of the ratios TTp/RDp and TTp/RTp versus wavelength, according to some embodiments.

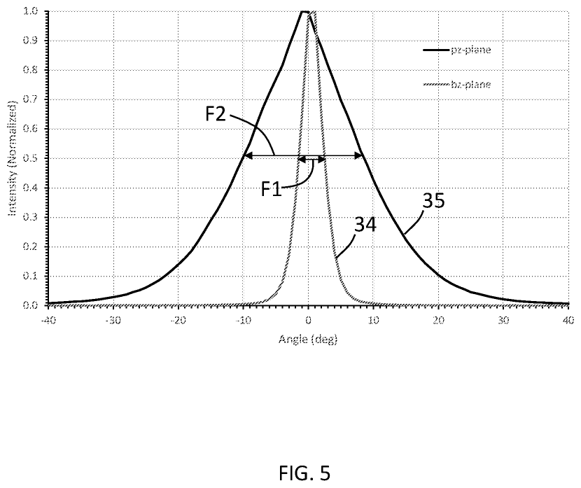

FIG. 5 is a plot of intensity distribution of the optical transmittance of an optically diffusive film, according to some embodiments, for block state light and for scattering angles in the bz-plane (e.g., scattering angle α1 in the bz-plane of FIG. 1B) and in the pz-plane (e.g., scattering angle α2 in the pz-plane of FIG. 2B). The intensity distributions are normalized to have a maximum value of 1.0. The plot of FIG. 5 was determined using a collimated white light emitting diode (LED) light source. In some embodiments, for a substantially normally incident light 30b polarized along the block-direction, a total optical transmittance of the optically diffusive film 200, 201 has first and second intensity distributions 34 and 35 in first and second scattering planes (bz-plane and pz-plane) comprising the respective block- and pass-directions. A scattering plane is generally a plane define by a direction of the incident light and a direction of scattered light. A wider distribution for the second intensity distribution than the first distribution (e.g., as quantified by the ratio of the full width at half maxima (FWHMs) of the distributions being at least 1.5) may be desired for some applications. In some embodiments, the different FWHMs result from the particles being elongated along substantially a same in-plane block-direction and having an average aspect ratio of greater than about 5 (or in another range described elsewhere herein), for example. In some embodiments, the first and second intensity distributions have full width at half maxima F1 and F2, respectively, where F2/F1≥1, or F2/F1≥1.5, or F2/F1≥2, or F2/F1≥2.5, or F2/F1≥3, or F2/F1≥3.5, or F2/F1≥4, or F2/F1≥10, or F2/F1≥50, or F2/F1≥100. F1 can be small (e.g., less than 1 degree) in some cases (e.g., when a large draw ratio is utilized), resulting in a large F2/F1 ratio. F2/F1 can be up to about 500, for example. In other embodiments, F2/F1 is no more than about 200, or no more than about 100, or no more than about 50, or no more than about 20, for examples. In some embodiments, F1 is in a range of about 0.5 degrees to about 10 degrees, or about 1 degree to about 8 degrees, or about 1.5 degrees to about 6 degrees, or about 2 degrees to about 5 degrees, for example. In some such embodiments, or in other embodiments, F2 is up to about 60 degrees, or up to about 40 degrees, or up to about 30 degrees, or up to about 25 degrees, for example.

For some applications, a higher haze is desired for light polarized along the block-direction than for light polarized along the pass-direction. In some embodiments, the optically diffusive film 200, 201 has an optical haze Hb for substantially normally incident light 30, 30b polarized along the block-direction and an optical haze Hp for substantially normally incident light 30, 30p polarized along the pass-direction, where Hb/Hp≥1.5, or Hb/Hp≥2, or Hb/Hp≥2.5, or Hb/Hp≥3, or Hb/Hp≥3.5. The optical haze of a film for a specified polarization state can be measured using a haze meter (e.g., a Haze-Gard haze meter available from BYK Corporation, Wesel, Germany) with an absorbing linear polarizer disposed on the film facing the light source of the haze meter with a pass axis of the polarizer aligned with the specified polarization state. The optical haze can be determined as described in the ASTM D1003-13 test standard except that the test specimen includes the absorbing linear polarizer disposed on the film. Typically, the optical haze Hb generally increases when increasing the difference in refractive indices of the particles and the binder along the block-direction and/or when increasing the number of the particles. The optical haze Hb can be high (e.g., greater than about 80% or greater than about 90%) when the refractive indices of the particles and the binder are substantially different (e.g., different by at least about 0.08 or at least about 0.1) along the block-direction, for example. The optical haze Hp can be low (e.g., less than about 2% or less than about 1%) when the refractive indices of the particles and the binder are closely matched (e.g., to within about 0.02, or about 0.01) along the pass-direction, for example. Hb/Hp may be up to about 100, or up to about 50, or up to about 25, or up to about 20, for example. In some embodiments, Hb is in a range of about 10% to about 100%, or about 15% to about 99%, or about 20% to about 98%, or about 20% to about 90%. In some such embodiments, or in other embodiments, Hp is in a range of about 0% to about 65%, or about 0.5% to about 60%, or about 1% to about 55%, or about 1.2% to about 50%, or about 5% to about 45%, or about 10% to about 40%. A higher haze for light 30b than for light 30p is schematically indicated in FIG. 2B, for example.

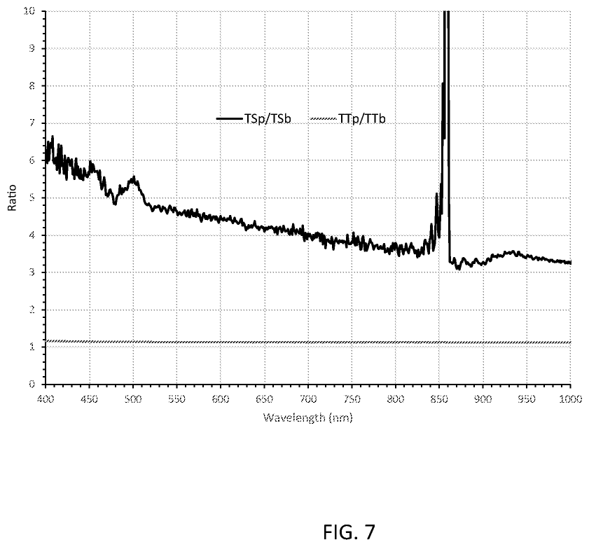

In some embodiments, for a substantially normally incident light 30 having the first wavelength, the optically diffusive film 200, 201 has a total optical transmittance TTb when the incident light is polarized along the block-direction. TTb may be similar to TTp (e.g., both may be greater than about 60%, or greater than about 70%) while a specular optical transmittance TSp when the incident light is polarized along the pass-direction can be substantially greater than a specular optical transmittance TSb when the incident light is polarized along the block-direction (e.g., substantially larger diffuse transmittance and correspondingly substantially smaller specular transmittance may be desired for light polarized along the block-direction than for light polarized along the pass-direction). FIG. 7 is a plot of TSp/TSb and TTp/TTb versus wavelength, according to some embodiments. In some embodiments, for the substantially normally incident light 30 having the first wavelength, 0.5≤TTp/TTb≤2. In some such embodiments, or in other embodiments, for the substantially normally incident light 30 having the first wavelength, the optically diffusive film 200, 201 has specular optical transmittances TSp and TSb when the incident light is polarized along the respective pass- and block-directions, where TSp/TSb≥2. In some such embodiments, or in other embodiments, 0.5≤TTp/TTb, or 0.6≤TTp/TTb, or 0.7≤TTp/TTb, or 0.8≤TTp/TTb, or 0.9≤TTp/TTb, or 1≤TTp/TTb. In some such embodiments, or in other embodiments, TTp/TTb≤2, or TTp/TTb≤1.9, or TTp/TTb≤1.8, or TTp/TTb≤1.7, or TTp/TTb≤1.6, or TTp/TTb≤1.5, or TTp/TTb≤1.4, or TTp/TTb≤1.3, or TTp/TTb≤1.25, or TTp/TTb≤1.2. In some such embodiments, or in other embodiments, TSp/TSb≥2, or TSp/TSb≥2.5, or TSp/TSb≥3, or TSp/TSb≥3.5, or TSp/TSb≥4, or TSp/TSb≥4.5, or TSp/TSb≥5, or TSp/TSb≥5.5, or TSp/TSb≥6. Typically, TSp/TSb generally increases when increasing the refractive index difference between the particles and the binder along the block-direction and/or decreasing the refractive index difference between the particles and the binder along the pass-direction. TSp/TSb can be up to about 150, or up to about 100, or up to about 75, or up to about 50, or up to about 30, for example.

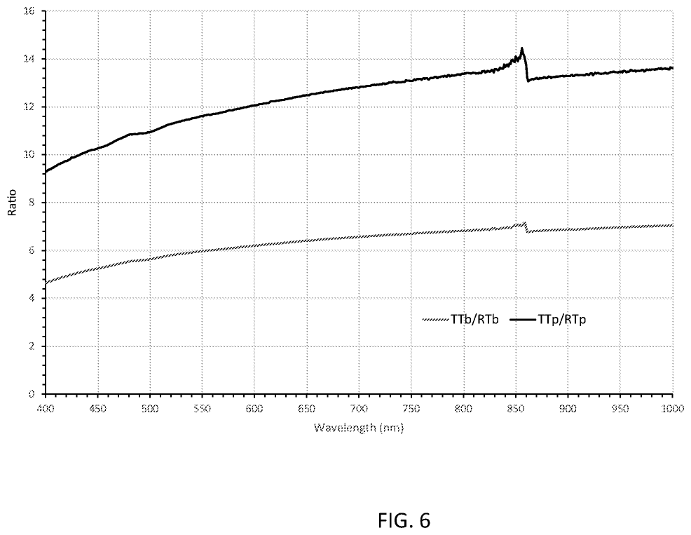

In some embodiments, for the substantially normally incident light 30 having the first wavelength, the optically diffusive film 200, 201 has: a total optical transmittance TTb and a total optical reflectance RTb when the incident light is polarized along the block-direction, where TTb/RTb≥2; and a total optical transmittance TTp and a total optical reflectance RTp when the incident light is polarized along the pass-direction, where TTp/RTp≥6. Low backscattering (e.g., as quantified by a TTb/RTb of at least 2 and/or by a TTp/RTp of at least 6) may be desired in some applications. FIG. 6 is a plot of the ratios TTb/RTb and TTp/RTp versus wavelength, according to some embodiments. In some embodiments, TTb/RTb≥2, or TTb/RTb≥3, or TTb/RTb≥3.5, or TTb/RTb≥4, or TTb/RTb≥4.5 In some such embodiments, or in other embodiments, TTp/RTp≥6, or TTp/RTp≥7, or TTp/RTp≥8, or TTp/RTp≥9, or TTp/RTp≥10, or TTp/RTp≥11. Typically, TTb/RTb generally increases when reducing the number of particles included in the binder and/or reducing the refractive index difference between the particles and the binder along the block-direction so that there is less backscattering. TTb/RTb can be up to about 15, or up to about 12, or up to about 10, for example. TTp/RTp can be large when the refractive indices of the particles and the binder are closely matched along the pass-direction. TTp/RTp can be up to about 100, or up to about 75, or up to about 50, or up to about 30, for example. In some embodiments, for the substantially normally incident light 30 having the first wavelength, RTb is less than about 25%, or less than about 20%, or less than about 17%, or less than about 15%. In some such embodiments, or in other embodiments, for the substantially normally incident light 30 having the first wavelength, RTp is less than about 20%, or less than about 15%, or less than about 10%, or less than about 8%.

In some embodiments, an optically diffusive film 200, 201 includes a plurality of particles 10, 11 dispersed in a binder 20. The particles 10, 11 and the binder 20 have respective indices n1b and n2b along a same in-plane (pb-plane) block-direction (b-direction) of the optically diffusive film 200, 201, and respective indices nip and n2p along an in-plane pass-direction (p-direction) orthogonal to the block-direction, such that for at least a first wavelength in a first wavelength range extending from about 400 nm to about 1000 nm (or in any wavelength range described elsewhere herein), a magnitude of a difference between n1b and n2b is greater than about 0.05 and a magnitude of a difference between nip and n2p is less than about 0.05. The magnitude of the difference between n1b and n2b can be in any range described elsewhere herein. The magnitude of the difference between nip and n2p can be in any range described elsewhere herein. In some embodiments, for a substantially normally incident light 30 having the first wavelength, the optically diffusive film 200, 201 has a total optical transmittance TTb and a total optical reflectance RTb when the incident light is polarized along the block-direction, and a total optical transmittance TTp and a total optical reflectance RTp when the incident light is polarized along the pass-direction. In some embodiments, TTb/RTb≥2 or TTb/RTb can be in any range described elsewhere herein. In some embodiments, or in other embodiments, TTp/RTp≥6 or TTp/RTp can be in any range described elsewhere herein. In some embodiments, for the substantially normally incident light having the first wavelength, 0.5≤TTp/TTb≤2 and the optically diffusive film 200, 201 has specular optical transmittances TSp and TSb when the incident light is polarized along the respective pass- and block-directions, where TSp/TSb≥2. TTp/TTb and TSp/TSb can be in any of the respective ranges described elsewhere herein.

In some embodiments, the optically diffusive film 200, 201 is formed by an extrusion process, as described further elsewhere herein. In some embodiments, the optically diffusive film 200, 201 includes a plurality of substantially parallel (e.g., within about 20, or within about 15 degrees, or within about 10 degrees, or within about 6 degrees, or within about 4 degrees of parallel) extrusion die-lines 40 making an angle θ of less than about 20, or less than about 15 degrees, or less than about 10 degrees, or less than about 6 degrees, or less than about 4 degrees with the pass-direction. The die-lines are marks or structures (e.g., ridges or channels) left in the film from the die used to extrude the film. The die-lines may be separated along the b-direction by greater distances than corresponding features of the die since the film may be stretched in a direction substantially orthogonal to the die-lines after extrusion. In some embodiments, at least some of the extrusion die-lines 40 form ridges 41. In some embodiments, the die-line ridges 41 have an average height h (see, e.g., FIG. 1B) of between about 0.1 and about 8 microns, or between about 0.2 and about 4 microns, or between about 0.4 and 2 microns, for example. In some embodiments, at least some of the extrusion die-lines 40 form channels 42. In some embodiments, the die-line channels 42 have an average depth d (see, e.g., FIG. 1B) of between about 0.1 and about 8 microns, or between about 0.2 and about 4 microns, or between about 0.4 and 2 microns, for example. In some embodiments, the die-lines may be sufficient large (e.g., wide and/or tall/deep) that the die-lies are readily visible with the unaided eye (e.g., of a person with 20/20 vision) when light (e.g., polarized along the pass-direction) from a point light source is transmitted though the film to form a projected image (e.g., when viewed from a distance of about 1 m from the projected image).

In some embodiments, an extruded optically diffusive film 201 extruded along a pass-direction (p-direction) includes a plurality of particles 11 dispersed in a binder 20, where the particles 11 are elongated along substantially a same in-plane block-direction (b-direction) orthogonal to the pass-direction. For example, the particles 11 can be elongated along a direction within about 20 degrees, or within about 10 degrees, or within about 5 degrees of a same direction (b-direction). The particles can have an average aspect ratio of greater than about 5, or greater than about 10, or greater than about 15, or greater than about 20, or greater than about 40, or greater than about 45, or greater than about 50, for example. The average aspect ratio can be up to about 1000, or up to about 600, or up to about 400, or up to about 200, or up to about 100, or up to about 80, for example. Except where otherwise indicated, the aspect ratio of a particle is the length (Lb) of the particle along the elongation direction divided by a length of the particle (Lz) along the thickness direction (z-direction) of the film. The average aspect ratio is the average (e.g., unweighted mean) over the particles of the aspect ratio of the particle. In some embodiments, one or both of Lb/Lp and Lp/Lz, for example, can have an average in a range described herein for the average aspect ratio (average of Lb/Lz) of the particles. The optically diffusive film 201 can include a plurality of substantially parallel extrusion die-lines 40 making an angle θ of less than about 20 degrees with the pass-direction or the angle θ can be in any range described elsewhere herein. In some embodiments, for a substantially normally incident light 30 having a first wavelength in a first wavelength range extending from about 400 nm to about 1000 nm or in another range described elsewhere herein, the optically diffusive film 201 has: a diffuse optical transmittance TDb and a diffuse optical reflectance RDb when the incident light is polarized along the block-direction, where TDb/RDb≥4; and a total optical transmittance TTp and a diffuse optical reflectance RDp when the incident light is polarized along the pass-direction, where TTp/RDp≥10. TDb/RDb and TTp/RDp can be in any of the respective ranges described elsewhere herein. In some embodiments, the extruded optically diffusive film 201 has a length L of greater than about 40 inches along the pass-direction or the length L can be in another range described elsewhere herein.

In some embodiments, the binder 20 comprises a first thermoplastic polymer and the particles 10, 11 comprise a different second thermoplastic polymer. In some embodiments, the first and second thermoplastic polymers are immiscible at a temperature greater than melting temperatures of the first and second thermoplastic polymers (i.e., at a temperature that is greater than each of a melting temperature of the first thermoplastic polymer and a melting temperature of the second thermoplastic polymer). In some such embodiments, or in other embodiments, the first thermoplastic polymer is birefringent and the second thermoplastic polymer is substantially optically isotropic.

Suitable materials for the binder 20 include, for example, polyethylene naphthalate (PEN), coPEN (copolyethylene naphthalate terephthalate copolymer), polyethylene terephthalate (PET), polyhexylethylene naphthalate copolymer (PHEN), glycol-modified PET (PETG or PETg), glycol-modified PEN (PENG), syndiotactic polystyrene (sPS), or blends thereof. Suitable sPS can be obtained from Idemitsu Kosan Co., Ltd. (Tokyo, Japan), for example. Atactic polystyrene (aPS) can optionally be blended with sPS (e.g., at about 5 to about 30 weight percent aPS) to adjust the refractive indices of the resulting layer and/or to reduce the haze of the layer (e.g., by reducing a crystallinity of the layer). Suitable PET can be obtained from Nan Ya Plastics Corporation, America (Lake City, SC), for example. PETG can be described as PET with some of the glycol units of the polymer replaced with different monomer units, typically those derived from cyclohexanedimethanol. PETG can be made by replacing a portion of the ethylene glycol (e.g., about 15 to about 60 mole percent or about 30 to about 40 mole percent) used in the transesterification reaction producing the polyester with cyclohexanedimethanol, for example. Suitable PETG copolyesters include GN071 available from Eastman Chemical Company (Kingsport, TN). PEN and coPEN can be made as described in U.S. Pat. No. 10,001,587 (Liu), for example. Glycol-modified polyethylene naphthalate (PENG) can be described as PEN with some of the glycol units of the polymer replaced with different monomer units and can be made by replacing a portion of the ethylene glycol (e.g., about 15 to about 60 mole percent or about 30 to about 40 mole percent) used in the transesterification reaction producing the polyester with cyclohexanedimethanol, for example. PHEN can be made as described for PEN in U.S. Pat. No. 10,001,587 (Liu), for example, except that a portion of the ethylene glycol (e.g., about 15 to about 60 mole percent, or about 30 to about 50 mole percent, or about 40 mole percent) used in the transesterification reaction is replaced with hexanediol. In some embodiments, the binder 20 comprises one or more of a polyester and a copolyester. For example, the binder may include a blend of a polyester and a copolyester. In some embodiments, the binder 20 comprises one or more of polyethylene terephthalate, glycol-modified polyethylene terephthalate, polyethylene naphthalate, and glycol-modified polyethylene naphthalate.

In some embodiments, the particles in the plurality of particles 10, 11 comprise a styrene-based polymer or copolymer (a polymer or copolymer containing styrene groups). In some embodiments, the particles in the plurality of particles 10, 11 comprise one or more of styrene butadiene, styrene acrylonitrile, styrene methyl methacrylate, and impact modified styrene acrylic. Impact modified styrene acrylic can incorporate monomer groups for improved impact resistance and/or toughness, as is known in the art. Suitable impact modified styrene acrylic include those available from Ineos Americas (League City, TX) under the ZYLAR tradename, for example. Other suitable styrene-based copolymers include those available from Ineos Americas (League City, TX) under the STYROLUX, STYROLUTION, and NAS tradenames, for example. Other classes of materials useful as the particles in the plurality of particles include polycarbonate polymers including bisphenol A; nylon polymers, such as Poly(hexamethylene adipamide) (Nylon 6,6) and Poly(caprolactam) (Nylon 6); and methacrylate polymers, such as Poly(2-phenylethyl methacrylate), for example. Choosing a polymer useful as the particles in the plurality of particles may be generally guided by choosing the polymer to substantially match the refractive index of the birefringent binder in the non-stretch in-plane direction, and by choosing the polymer being immiscible with the binder polymer system, remaining non-birefringent during the stretching process, and not degrading during the melt processing stage.

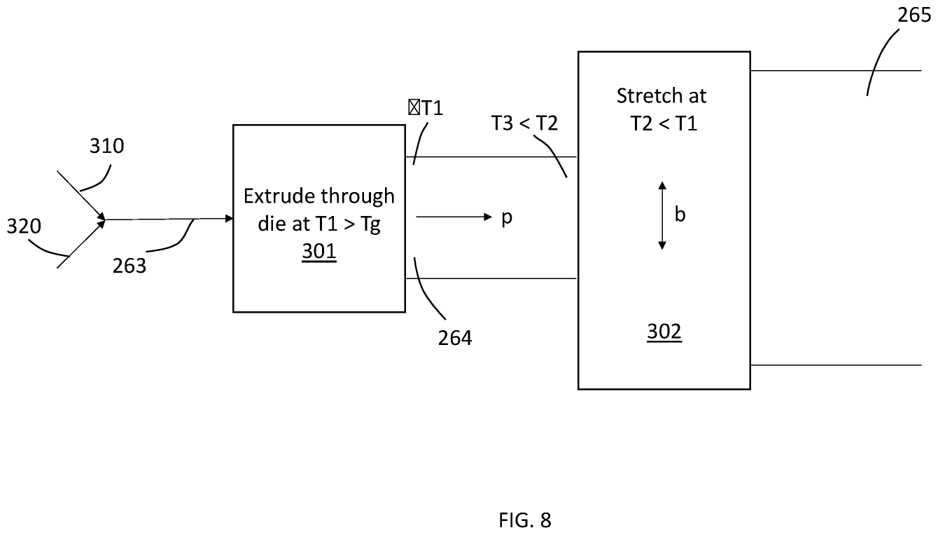

FIG. 8 is a schematic process flow diagram of a method of making an optically diffusive film, according to some embodiments. In some embodiments, a method of making an optically diffusive film 201, 265 includes: extruding (step 301) an immiscible blend 263 of a minor phase material and a major phase material 310 and 320 through a die and along a pass-direction (p-direction) at a first temperature T1 greater than glass transition temperatures (Tg) of the minor and major phase materials 310 and 320 resulting in an extruded mixture 264 at substantially the first temperature T1 (e.g., within about 10° C. or within about 5° C. of T1); and stretching (step 302) the extruded mixture 264 along a block-direction (b-direction), substantially orthogonal (e.g., within about 20 degrees, or within about 10 degrees, or within about 5 degrees of orthogonal) to the pass-direction, at a second temperature T2 less than the first temperature T1 resulting in a plurality of particles 11 dispersed in a binder 20, where the binder 20 and each of at least a majority of the particles 11 have respective indices n2b and n1b along the block-direction and respective indices n2p and nip along the pass-direction, such that for at least a first wavelength in a first wavelength range extending from about 400 nm to about 1000 nm, or in any wavelength range described elsewhere herein, a magnitude of a difference between n1b and n2b is greater than about 0.05 and a magnitude of a difference between nip and n2p is less than about 0.05. The magnitude of the difference between n1b and n2b can be any range described elsewhere herein. The magnitude of the difference between nip and n2p can be any range described elsewhere herein. The at least a majority of the particles 11 can include at least about 60 percent, or at least about 70 percent, or at least 80 percent, or at least about 90 percent, or substantially all of the particles 11 (by number). The at least a majority of the particles 11 can include at least about 60 percent, or at least about 70 percent, or at least 80 percent, or at least about 90 percent, or substantially all of a total mass of the particles 11. The minor phase material of the immiscible blend generally comprises less than half of a total volume of the immiscible blend and typically defines a discontinuous phase. The major phase material of the immiscible blend generally comprises greater than half of the total volume of the immiscible blend and typically defines a continuous phase.

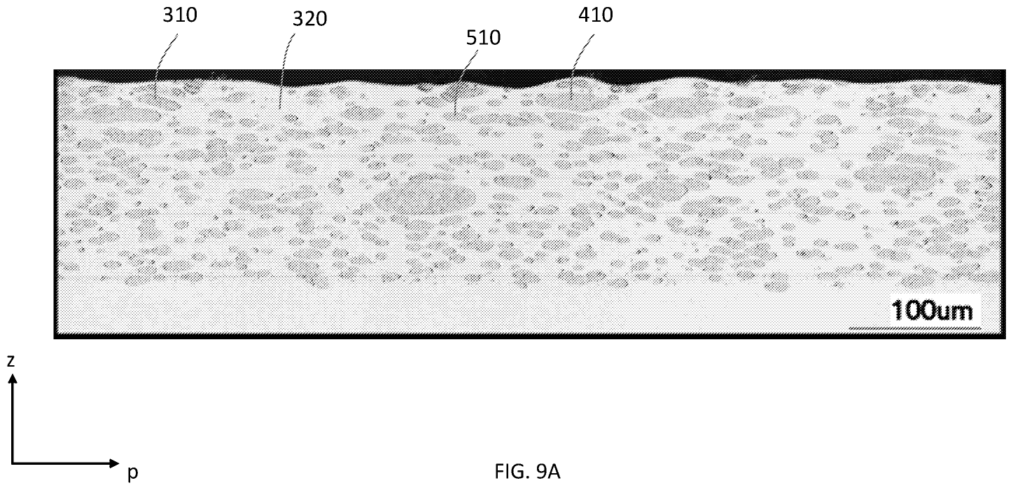

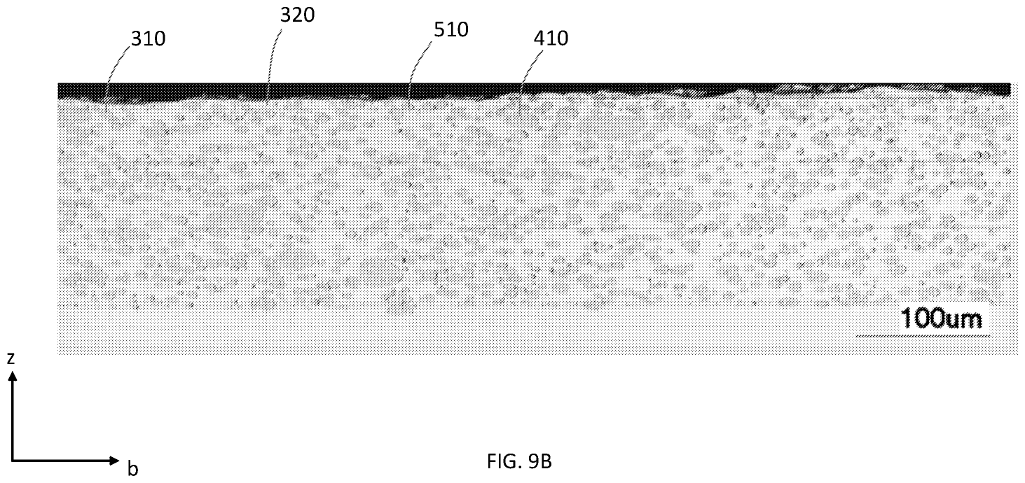

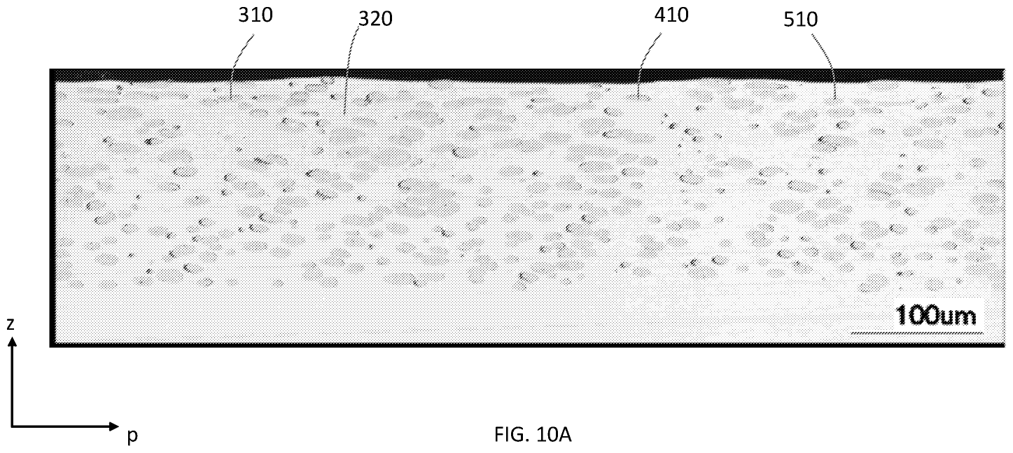

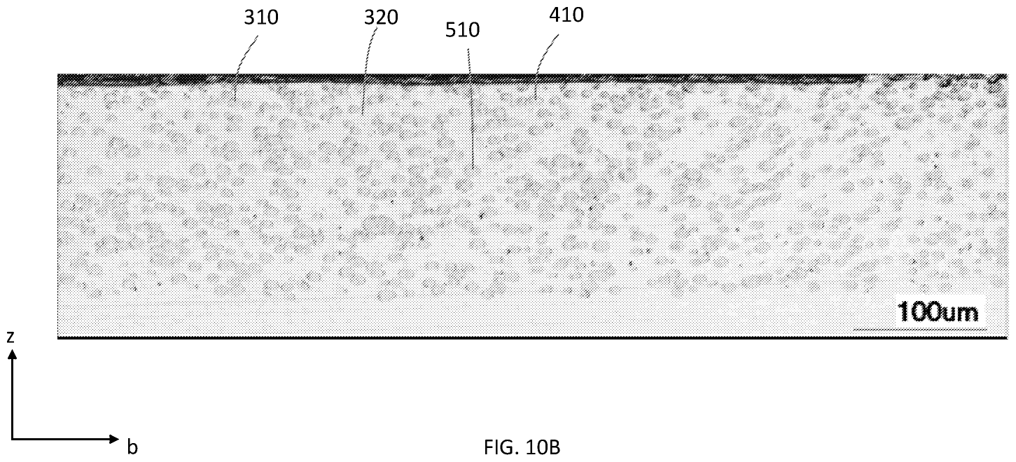

FIGS. 9A-9B are micrographs of cross-sections of an extruded mixture (Example 1) prior to stretching in the pz-and bz-planes, respectively. FIGS. 10A-10B are micrographs of cross-sections of an extruded mixture (Example 2) prior to stretching in the pz-and bz-planes, respectively. In some embodiments, the extruded mixture 264 (prior to stretching) includes a plurality of discrete domains 410. In some embodiments, the extruded mixture includes a plurality of substantially spherical domains 510. For example, the plurality of discrete domains 410 can include a plurality of substantially spherical domains 510. In some embodiments, the plurality of discrete domains 410 may also include domains that are not substantially spherical. A substantially spherical domain is a domain where a largest sphere that can be inscribed in the domain has a diameter Di, a smallest sphere that can contain the domain has a diameter Do, and Do/Di is less than about 4. In some embodiments, at least some (e.g., a least a majority) of the substantially spherical domains have a Do/Di less than about than about 3.5, or less than about 3, or less than about 2.5. It has been found that the domains can be made more spherical by using a bigger die (e.g., larger die gap) with a slower extrusion rate and/or using a lower viscosity major phase material 320 (e.g., at a given temperature) and/or a higher extrusion temperature (e.g., to lower the viscosity of the major phase material 320). Having the domains be substantially spherical in the extruded mixture, as opposed to substantially elongated along the p-direction, for example, has been found to result in larger aspect ratio particles after stretching along the b-direction, for example, and this has been found to result in desired scattering properties (e.g., a high F2/F1 as described elsewhere herein).

In some embodiments, the first temperature T1 is greater than melt temperatures of the minor and major phase materials 310 and 320. In some embodiments, the first temperature T1 is greater than about 200 degrees centigrade, or greater than about 220 degrees centigrade, or greater than about 240 degrees centigrade, or greater than about 260 degrees centigrade, or greater than about 270 degrees centigrade, for example. In some embodiments, the first temperature is less than about 400 degrees centigrade, for example. In some embodiments, the second temperature is about 5 to about 50, or about 5 to about 40, or about 5 to about 30, or about 5 to about 20, or about 8 to about 30 degrees centigrade greater the glass transition temperatures of the minor and major phase materials. In some such embodiments, or in other embodiments, prior to the stretching of the extruded mixture 264 along the block-direction at the second temperature T2, a temperature of the extruded mixture 264 is reduced to a third temperature T3 less than the second temperature T2. For example, the extruded mixture can be cast against a casting wheel (sometimes referred to in the art as a chill roll or a casting drum) to rapidly cool the mixture resulting in a cast film. In some embodiments, the third temperature T3 is about a room temperature (e.g., a temperature in a range of about 18 to about 30 degrees centigrade).

In some embodiments, the discrete domains in the extruded mixture and/or the substantially spherical domains in the extruded mixture at least mostly comprise the minor phase material. For example, the minor phase material can make up at least about 80 percent, or at least about 90 percent, or at least about 95 percent by weight of the domains. In some embodiments, the discrete domains in the extruded mixture and/or the substantially spherical domains in the extruded mixture are dispersed in a material at least mostly comprises the major phase material. For example, the major phase material can make up at least about 70 percent, or at least about 80 percent, or at least about 90 percent, or at least about 95 percent by weight of the material in which the domains are dispersed.

### Examples

TABLE 1
Materials Used in the Examples

| Name | Description | Source |
|---|---|---|
| PET Clear 62 | Polyethylene terephthalate (PET) | Made as the reaction |
| | with 0.62 intrinsic viscosity (IV) | product of terephthalic |
| | | acid and ethylene glycol |
| | | polymerized to a target |
| | | 0.62 IV (as measured in an |
| | | o-chlorobenzene/phenol |
| | | 60/40 solvent blend). |
| PET 9921 | Polyethylene terephthalate (PET) | Eastman Chemicals, |
| | with 0.80 intrinsic viscosity | Knoxville, TN |
| ZYLAR 960 | Impact modified styrene acrylic | Ineos Americas (League |
| | copolymer | City, TX) |
| STYROLUX 3G55 | Styrene butadiene copolymer | Ineos Americas (League |
| | | City, TX) |
| NAS 90 | Styrene methyl methacrylate | Ineos Americas (League |
| | | City, TX) |
| PETg | Glycol-modified PET copolyester | Eastman Chemicals |
| | available under the tradename GN071 | (Knoxville, TN) |
| PETg-i5 | Polyester-based ionomer | Made as described in U.S. |
| | | Pat. Appl. Pub. No. |
| | | 2007/0298271 (Liu et al.) |
| | | for “Polyester O”. |

Optically diffusive films of Examples 1-5 were made via coextrusion and batch orienting using materials shown in Table 2. The temperature of the extruder was about 277 degrees Celsius.

TABLE 2

| | Material | % wt/pph | Material | % wt/pph | Material | % wt/pph | Thickness |
|---|---|---|---|---|---|---|---|
| Ex. | #1 | Mat. #1 | #2 | Mat. #2 | #3 | Mat. #3 | (μm) |
| 1 | PET Clear 62 | 50%/5 | ZYLAR 960 | 30%/3 | PETg | 20%/2 | 88 |
| 2 | PET Clear 62 | 75%/7.5 | STYROLUX | 20%/2 | PETg-i5 | 5%/0.5 | 90 |
| | | | 3G55 | | | | |
| 3 | PET Clear 62 | 60%/9 | STYROLUX | 40%/6 | | | 125 |
| | | | 3G55 | | | | |
| 4 | PET 9921 | 70%/7 | NAS 90 | 30%/3 | | | 88 |
| 5 | PET Clear 62 | 70%/21 | STYROLUX | 30%/9 | | | 118 |
| | | | 3G55 | | | | |

Material #1 and material #3 (when included) were the polyester phase materials and Materials #2 was the co-polystyrene phase material. The weight percent and the pounds per hour (pph) of these materials in the extruder input are indicated in Table 2. The polyester phase and the co-polystyrene phase were immiscible and exhibited two distinct phases after extrusion and after stretching.

After extrusion and before stretching, the extruded mixtures were cooled by casting the extruded mixtures against a casting wheel. For Examples 1 to 4, a two layer co-extrusion was performed where the layer already described (the blend layer) was on the air-side during the casting process and the wheel-side layer was composed of the same composition as the polyester phase in the blend layer and was fed at the same rate as the total blend layer. For Example 5, a 3 layer coextrusion was utilized where the center layer was the blend layer and the other two layers had the same composition as the polyester phase of the blend layer and each of the two streams was fed at a rate of half of the total blend layer rate. An 8″ extrusion die was used for all examples. The die gap was 60 mils for Examples 1-4 and 100 mils for Example 5.

The stretching process for all these films was performed on a batch orientor (Karo IV from Brueckner Group, Portsmouth, NH). A pre-heat and stretch temperature of 95° C. was utilized. The stretching was a constrained stretch with a draw ratio of about 6:1 in the transverse direction (TD) orthogonal to the machine direction (MD). PET stretched at these conditions has refractive indices of about 1.66 in the stretch direction (TD), 1.56 in the in-plane direction perpendicular to the stretch direction (the MD direction), and 1.53 in the thickness direction measured at 631 nm with a refractometer (Metricon Corporation, Pennington, NJ). The thicknesses of the films after stretching are given in Table 2.

The tendency of the films to scatter polarized light was characterized using a Haze Gard (BYK Corporation, Wesel, Germany). The haze of light polarized in the block direction (TD) was determined by positioning a high contrast ratio absorbing polarizer (with its pass-state transmission axis aligned with the stretch direction of the example film) on the incoming light side of the example film with transparent tape (3M 375 from 3M, Saint Paul, MN) applied to the air-side of the film to reduce scattering from the surface roughness of the example films. The samples were oriented so that the wheel-side of the film was toward the incoming light. For the pass-state haze the absorbing polarizer is aligned with the non-stretch direction (MD) of the example film. Results from the polarized haze measurements are provided in Table 3.

The angular distribution of the scattered light was measured with a Conoscope (ELDIM Corporation, Hérouville-Saint-Clair, France) with a cone angle of 80 degrees. A collimated white (LED) light source was utilized with an absorbing polarizer placed between the light source and the example film. Measurements were taken with the transmission axis of the polarized in the block direction and the Full Width Half Max (FWHM) of the scattering patterns along the MD and TD directions were determined and are reported in Table 3.

TABLE 3

| | | | FWHM | FWHM |
|---|---|---|---|---|
| | | | (degrees) | (degrees) |
| | | | Block State | Block State |
| | | | measured in | measured in |
| | | | scattering | scattering |
| | Haze (%) | Haze (%) | plane parallel | plane parallel |
| | Block | Pass | to the MD | to the TD |
| Ex. | State | State | direction | direction |
| 1 | 61.2 | 16.2 | 5 | 2 |
| 2 | 21 | 1.41 | 4 | 2 |
| 3 | 80.8 | 11.1 | 17 | 5 |
| 4 | 97.5 | 33.6 | 3 | 3 |
| 5 | 54.3 | 14.7 | 20 | 5 |

The reflective characteristics of the example films were determined by measuring the films reflectivity in an integrating sphere. The total reflectance, which is also referred to as the Reflectance with the Specular Included (RSIN), was measured by collecting all light reflecting from the example films impinging from all angles while the diffuse reflectance, which is also known as the Reflectance with the Specular Excluded (RSEX), was measured by allowing light to escape the integrating sphere that would produce a specular reflection. A LAMBDA 1050 spectrophotometer (PerkinElmer, Inc., Waltham, MA) was used in the measurements. The resulting reflectances averaged over a wavelength range of 450 nm to 650 nm are shown in Table 4.

TABLE 4

| | Diffuse | Total | Diffuse | Total |
|---|---|---|---|---|
| | Reflectance | Reflectance | Reflectance | Reflectance |
| | Block State | Block State | Pass State | Pass State |
| Ex. | (%) | (%) | (%) | (%) |
| 1 | 5.89 | 12.31 | 2.50 | 7.18 |
| 2 | 1.97 | 7.83 | 0.96 | 5.61 |
| 3 | 9.68 | 16.98 | 4.30 | 9.92 |
| 4 | 3.44 | 10.30 | 0.85 | 5.57 |
| 5 | 1.75 | 7.98 | 0.77 | 5.56 |

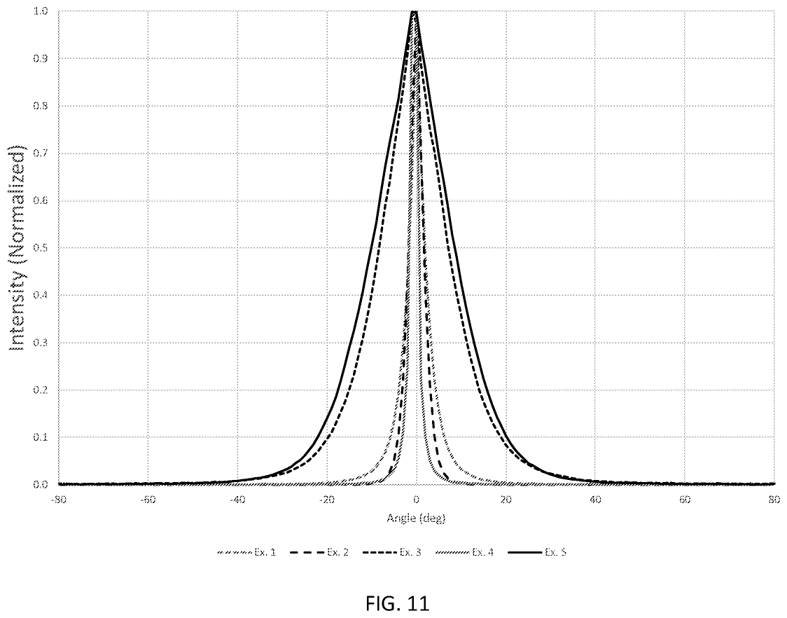

The scattering of example films in a plane defined by the machine direction and the thickness direction (pz-plane) for the block-state polarization (normalized by the maximum counts achieved) is shown in FIG. 11. An example of the asymmetric scattering of these films is shown in FIG. 5 for Example 5. Micrographs of cross-sections of the example films before stretching are shown in FIGS. 9A-9B for Example 1 and in FIGS. 10A-10B for Example 2.

Average aspect ratios of the particles before stretching the cast films were determined using an optical microscope to examine cross-sections in the bz-plane and the pz-plane. The ratios Lp/Lz and Lb/Lz were determined for particles in the cross-section and an average of the ratios were determined. Results are provided in Table 5.

TABLE 5

| Ex. | Lp/Lz | Lb/Lz |
|---|---|---|
| 1 | 2.16 | 1.51 |
| 2 | 2.42 | 1.33 |
| 3 | 3.61 | 1.50 |
| 4 | 15.50 | 1.54 |
| 5 | 1.27 | 1.30 |

The corresponding aspect ratios for the stretched films were calculated assuming that the draw ratio of about 6 resulted in stretching by a factor of 6 in the TD direction and thinning by a factor of 6 in the thickness direction, as would be expected for a standard tenter as used in the Examples. Results are provided in Table 6.

TABLE 6

| Ex. | Lp/Lz | Lb/Lz |
|---|---|---|
| 1 | 12.94 | 54.51 |
| 2 | 14.51 | 47.98 |
| 3 | 21.63 | 54.00 |
| 4 | 93.01 | 55.40 |
| 5 | 7.62 | 46.97 |

The aspect ratios that would have resulted if the cast films were stretched using a parabolic tenter with a draw ratio of 6 was calculated by assuming stretching by a factor of 6 in the TD direction and contraction and thinning by a factor of the square root of 6 in the respective MD and thickness directions. Results are provided in Table 7.

TABLE 7

| Ex. | Lp/Lz | Lb/Lz |
|---|---|---|
| 1 | 2.16 | 22.25 |
| 2 | 2.42 | 19.59 |
| 3 | 3.61 | 22.04 |
| 4 | 15.50 | 22.61 |
| 5 | 1.27 | 19.18 |

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations, or variations, or combinations of the specific embodiments discussed herein. Therefore, it is intended that this disclosure be limited only by the claims and the equivalents thereof.

1. An optically diffusive film comprising a plurality of particles dispersed in a binder, the particles and the binder comprising respective indices n1b and n2b along a same in-plane block-direction of the optically diffusive film, and respective indices nip and n2p along an in-plane pass-direction orthogonal to the block-direction, such that for at least a first wavelength in a first wavelength range extending from about 400 nm to about 1000 nm:
a magnitude of a difference between n1b and n2b is greater than about 0.05; and
a magnitude of a difference between nip and n2p is less than about 0.05;
wherein, for a substantially normally incident light having the first wavelength, the optically diffusive film has:
a diffuse optical transmittance TDb and a diffuse optical reflectance RDb when the incident light is polarized along the block-direction, TDb/RDb≥4; and
a total optical transmittance TTp and a diffuse optical transmittance TDp when the incident light is polarized along the pass-direction, TTp/TDp≥1.1.

2. The optically diffusive film of claim 1, wherein for the substantially normally incident light having the first wavelength, the optically diffusive film has a diffuse optical reflectance RDp when the incident light is polarized along the pass-direction, TTp/RDp≥10.

3. The optically diffusive film of claim 1, wherein for a substantially normally incident light polarized along the block-direction, a total optical transmittance of the optically diffusive film has first and second intensity distributions in first and second scattering planes comprising the respective block- and pass-directions, the first and second intensity distributions having full width at half maxima F1 and F2, respectively, F2/F1≥1.5.

4. The optically diffusive film of claim 1 formed by an extrusion process, wherein the optically diffusive film comprises a plurality of substantially parallel extrusion die-lines making an angle of less than about 20 degrees with the pass-direction.

5. The optically diffusive film of claim 1, wherein the binder comprises a birefringent first thermoplastic polymer and the particles comprise a substantially optically isotropic second thermoplastic polymer, the first and second thermoplastic polymers being immiscible at a temperature greater than melting temperatures of the first and second thermoplastic polymers.

6. The optically diffusive film of claim 1 having an optical haze Hb for substantially normally incident light polarized along the block-direction and an optical haze Hp for substantially normally incident light polarized along the pass-direction, Hb/Hp≥1.5.

7. The optically diffusive film of claim 1, wherein the particles are elongated along the in-plane block-direction and have an average aspect ratio of greater than about 10.

8. An optically diffusive film comprising a plurality of particles dispersed in a binder, the particles and the binder comprising respective indices n1b and n2b along a same in-plane block-direction of the optically diffusive film, and respective indices nip and n2p along an in-plane pass-direction orthogonal to the block-direction, such that for at least a first wavelength in a first wavelength range extending from about 400 nm to about 1000 nm:
a magnitude of a difference between n1b and n2b is greater than about 0.05; and
a magnitude of a difference between nip and n2p is less than about 0.05;
wherein, for a substantially normally incident light having the first wavelength, the optically diffusive film has:
a total optical transmittance TTb and a total optical reflectance RTb when the incident light is polarized along the block-direction, TTb/RTb≥2; and
a total optical transmittance TTp and a total optical reflectance RTp when the incident light is polarized along the pass-direction, TTp/RTp≥6.

9. The optically diffusive film of claim 8, wherein for the substantially normally incident light having the first wavelength:
0.5≤TTp/TTb≤2; and
the optically diffusive film has specular optical transmittances TSp and TSb when the incident light is polarized along the respective pass- and block-directions, TSp/TSb≥2.

10. The optically diffusive film of claim 8, wherein for at least the first wavelength:
a magnitude of a difference between n1b and n2b is greater than about 0.06; and
a magnitude of a difference between nip and n2p is less than about 0.04.

11. An extruded optically diffusive film extruded along a pass-direction and comprising:
a plurality of particles dispersed in a binder, the particles elongated along substantially a same in-plane block-direction orthogonal to the pass-direction and having an average aspect ratio of greater than about 5; and
a plurality of substantially parallel extrusion die-lines making an angle of less than about 20 degrees with the pass-direction;
wherein, for a substantially normally incident light having a first wavelength in a first wavelength range extending from about 400 nm to about 1000 nm, the optically diffusive film has:
a diffuse optical transmittance TDb and a diffuse optical reflectance RDb when the incident light is polarized along the block-direction, TDb/RDb≥4; and
a total optical transmittance TTp and a diffuse optical reflectance RDp when the incident light is polarized along the pass-direction, TTp/RDp≥10.

12. The extruded optically diffusive film of claim 11 having a length of greater than about 40 inches along the pass-direction.

13. A method of making an optically diffusive film, comprising:
extruding an immiscible blend of a minor phase material and a major phase material through a die and along a pass-direction at a first temperature greater than glass transition temperatures of the minor and major phase materials resulting in an extruded mixture at substantially the first temperature and comprising a plurality of substantially spherical domains; and
stretching the extruded mixture along a block-direction, substantially orthogonal to the pass-direction, at a second temperature less than the first temperature resulting in a plurality of particles dispersed in a binder, wherein the binder and each of at least a majority of the particles comprise respective indices n2b and n1b along the block-direction and respective indices n2p and nip along the pass-direction, such that for at least a first wavelength in a first wavelength range extending from about 400 nm to about 1000 nm:
a magnitude of a difference between n1b and n2b is greater than about 0.05; and
a magnitude of a difference between nip and n2p is less than about 0.05.

14. The method of claim 13, wherein the second temperature is about 5 to about 50 degrees centigrade greater the glass transition temperatures of the minor and major phase materials, and wherein prior to the stretching of the extruded mixture along the block-direction at the second temperature, a temperature of the extruded material is reduced to a third temperature less than the second temperature.

15. The method of claim 13, wherein the substantially spherical domains in the extruded mixture at least mostly comprise the minor phase material.

16. The method of claim 13, wherein the optically diffusive film comprises a plurality of substantially parallel extrusion die-lines making an angle of less than about 20 degrees with the pass-direction.

17. The optically diffusive film of claim 8 formed by an extrusion process, wherein the optically diffusive film comprises a plurality of substantially parallel extrusion die-lines making an angle of less than about 20 degrees with the pass-direction.

18. The optically diffuse film of claim 1, wherein TTp/TDp is no more than about 5.
